(19) United States
(12) Patent Application Publication
(10) Pub. No.: US 2019/0005702 A1
(43) Pub. Date: Jan. 3, 2019

(54) DRAWING CONTROL APPARATUS

(71) Applicant: Mitsubishi Electric Corporation, Tokyo (JP)

(72) Inventors: Yasuaki TAKIMOTO, Tokyo (JP); Takehisa MIZUGUCHI, Tokyo (JP)

(73) Assignee: Mitsubishi Electric Corporation, Tokyo (JP)

(21) Appl. No.: 15/752,380

(22) PCT Filed: Aug. 25, 2015
(86) PCT No.: PCT/JP2015/073876

§ 371 Date: Feb. 13, 2018

(51) Int. Cl. G06T 15/00; G09G 5/00; G09G 5/377; G09G 5/36

(52) U.S. Cl. CPC G06T 15/005; G09G 5/006; G09G 5/377; G09G 2310/08; G09G 2360/18; G09G 2380/10; G09G 5/363

(57) ABSTRACT

A drawing control apparatus includes: a drawing unit for drawing a plurality of images by executing a plurality of drawing tasks, each given a priority level, in each period; an output unit for combining and outputting the images drawn by the drawing unit in each period; a drawing time estimating unit for estimating a drawing time of each of one or more drawing commands included in a drawing task; and a drawing adjustment unit for planning a sequence for executing the drawing tasks on the basis of the drawing times estimated by the drawing time estimating unit and controlling the drawing unit. The drawing adjustment unit causes the drawing unit to execute the drawing tasks planned to be executed in a current period in descending order of priority and to execute some or all of the drawing commands of drawing tasks that have not been completed by output timing of the current period after execution of drawing tasks with higher priority than the uncompleted drawing tasks in a next period.

### TECHNICAL FIELD

This disclosure relates to a drawing control apparatus for executing periodically a plurality of drawing tasks given a priority level.

### BACKGROUND ART

In existing three-dimensional graphics processors, it is difficult to interrupt and switch a drawing process to another drawing process at arbitrary timing, and few perform priority processing certainly.

Thus, in the use of a three-dimensional graphics processor for an instrument panel (a so-called graphic instrument panel) having a display such as liquid crystal, when the three-dimensional graphics processor is used in common between a drawing of an indicating needle of a meter to which a high priority level is set in order to guarantee real-time performance and a drawing of a frame of the meter to which a lower priority level is set, there is a case in which the real-time performance is not guaranteed because a drawing process with the high-priority level cannot be started until a drawing process with the low-priority level is completed.

Accordingly, a drawing control apparatus disclosed in Patent Literature 1 estimates a time required for a drawing process, and changes the sequence of drawing processes or divides a drawing process, thus allowing a high-priority drawing process to be executed while avoiding interruption of a drawing process being executed.

### CITATION LIST

### Patent Literature

Patent Literature 1: WO 2013/102956 A

### SUMMARY OF INVENTION

### Technical Problem

In a case in which a high-priority drawing process and a low-priority drawing process are performed in each period, however, such a situation in which the time required for the high-priority drawing process and the time required for the low-priority drawing process become longer than a period has not been considered. Thus, in the situation in which the time required for the high-priority drawing process and the time required for the low-priority drawing process become longer than a period, the high-priority drawing process is not always performed certainly, which poses a problem of failing to guarantee the real-time performance of drawing. Furthermore, when an error is present in the estimation of the time required for a drawing process or when abnormality or the like occurs to increase the time required for a drawing process, there is also the problem of failing to guarantee the real-time performance of drawing.

Embodiments of this disclosure have been made to solve such problems as described above, and an object thereof is to certainly execute a high-priority drawing task when a plurality of drawing tasks each given a priority level is present.

### Solution to Problem

A drawing control apparatus according to an aspect of the embodiments includes: a drawing unit for executing in each period a plurality of drawing tasks given a priority level, and drawing a plurality of images; an output unit for synthesizing and outputting the images drawn by the drawing unit in each period; a drawing time estimating unit for estimating a drawing time of each of one or more drawing commands included in a drawing task; and a drawing adjustment unit for planning an execution sequence of the plurality of drawing tasks on a basis of the drawing times estimated by the drawing time estimating unit, and controlling the drawing unit, wherein the drawing adjustment unit is configured to cause the drawing unit to execute in descending order of priority level the plurality of drawing tasks that is planned to be executed in a current period, and to execute some or all of the drawing commands of a drawing task that is not expected to be completed by output timing at which outputting of images that are drawn in the current period is started in a next period after executing a drawing task with a priority level higher than the drawing task that is not expected to be completed.

### Advantageous Effects of Invention

According to an aspect of the embodiments, a plurality of drawing tasks planned to be executed in the current period are executed in descending order of priority level by the drawing unit, and some or all of drawing commands of drawing tasks that have not been completed by output timing, at which output of images drawn in the current period is started, are executed after execution of drawing tasks with higher priority than the uncompleted drawing task in the next period, which allows drawing tasks with high priority to be certainly executed in each period.

### BRIEF DESCRIPTION OF DRAWINGS

FIG. 1 is a block diagram illustrating an exemplary configuration of a drawing control apparatus according to First Embodiment of this disclosure.

FIG. 2 is a diagram for explaining a frame buffer, layers and a video output in the drawing control apparatus according to First Embodiment.

FIG. 3 is a diagram for explaining double buffering with the layers in the drawing control apparatus according to First Embodiment.

FIG. 4 is a timing chart for explaining a drawing process in each period in the drawing control apparatus according to First Embodiment.

FIG. 5 is a timing chart for explaining a plan made by a drawing adjustment unit of the drawing control apparatus according to First Embodiment.

FIG. 6 is a flowchart illustrating operation of the drawing control apparatus according to First Embodiment.

FIG. 7 is a flowchart illustrating details of a process performed in step ST12 in FIG. 6.

FIG. 8 is a timing chart for explaining a plan made by a drawing adjustment unit of a drawing control apparatus according to Second Embodiment of this disclosure.

FIG. 9 is a flowchart illustrating operation of the drawing control apparatus according to Second Embodiment of this disclosure.

FIG. 10 is a timing chart for explaining a plan made by a drawing adjustment unit of a drawing control apparatus according to Third Embodiment of this disclosure.

FIG. 11 is a block diagram illustrating an example configuration of a drawing control apparatus according to Fourth Embodiment of this disclosure.

FIG. 12 is a hardware configuration diagram of the drawing control apparatus according to the embodiments of this disclosure.

### DESCRIPTION OF EMBODIMENTS

Hereinafter, to explain this disclosure in detail, embodiments according to this disclosure are described with reference to the accompanying drawings.

### First Embodiment

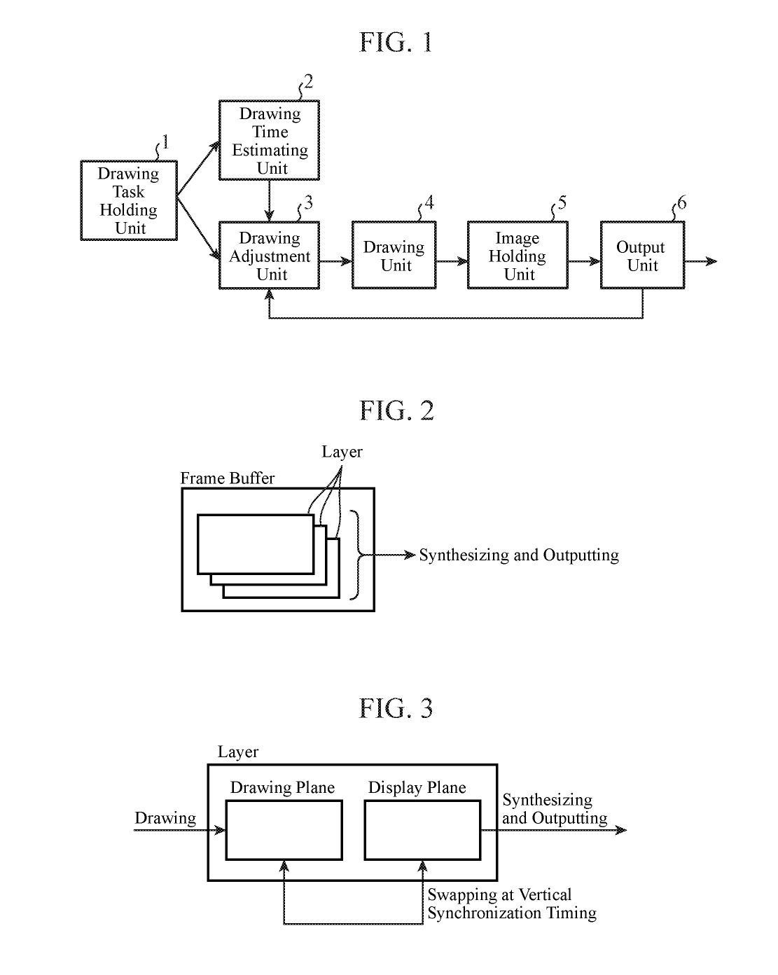

FIG. 1 is a block diagram illustrating an exemplary configuration of a drawing control apparatus according to First Embodiment. As illustrated in FIG. 1, the drawing control apparatus according to First Embodiment includes a drawing task holding unit 1 for holding drawing tasks, each being information indicating the content of a drawing process, a drawing time estimating unit 2 for estimating a drawing time for each of drawing commands contained in the drawing tasks, a drawing adjustment unit 3 for planning an execution sequence of drawing tasks on the basis of the estimated drawing times, a drawing unit 4 for executing the drawing tasks in accordance with a plan, an image holding unit 5 for holding images drawn by the drawing unit 4, and an output unit 6 for outputting images held by the image holding unit 5.

The drawing unit 4, the image holding unit 5, and the output unit 6 output images consecutively in each predetermined period defined by, for example, vertical synchronization timing. Vertical synchronization timing corresponds to output timing at which output of an image drawn during a current period starts. The output unit 6 generates vertical synchronization timing, and outputs vertical synchronization signals indicating the vertical synchronization timing to the drawing adjustment unit 3.

FIG. 2 is a diagram for explaining a frame buffer, layers, and video output in the drawing control apparatus according to First Embodiment. The image holding unit 5 is a frame buffer and includes a plurality of layers. One drawing task is assigned to one layer.

FIG. 3 is a diagram for explaining double buffering with the layers in the drawing control apparatus according to First Embodiment. Each layer of the image holding unit 5 comprises a double-buffered configuration, and includes both a drawing plane and a display plane.

When executing a drawing task, the drawing unit 4 writes drawing data into a buffer area corresponding to a drawing plane of the layer to which the drawing task is assigned, and generates image data. The drawing unit 4 also switches the display plane and the drawing plane at vertical synchronization timing in response to a request from the drawing adjustment unit 3, sets a buffer area that is a display plane in a previous period to a drawing plane in a current period, and performs drawing. The output unit 6 synthesizes the display planes of the respective layers of the image holding unit 5 at vertical synchronization timing, and outputs a synthesized result to a display or the like, which is not illustrated.

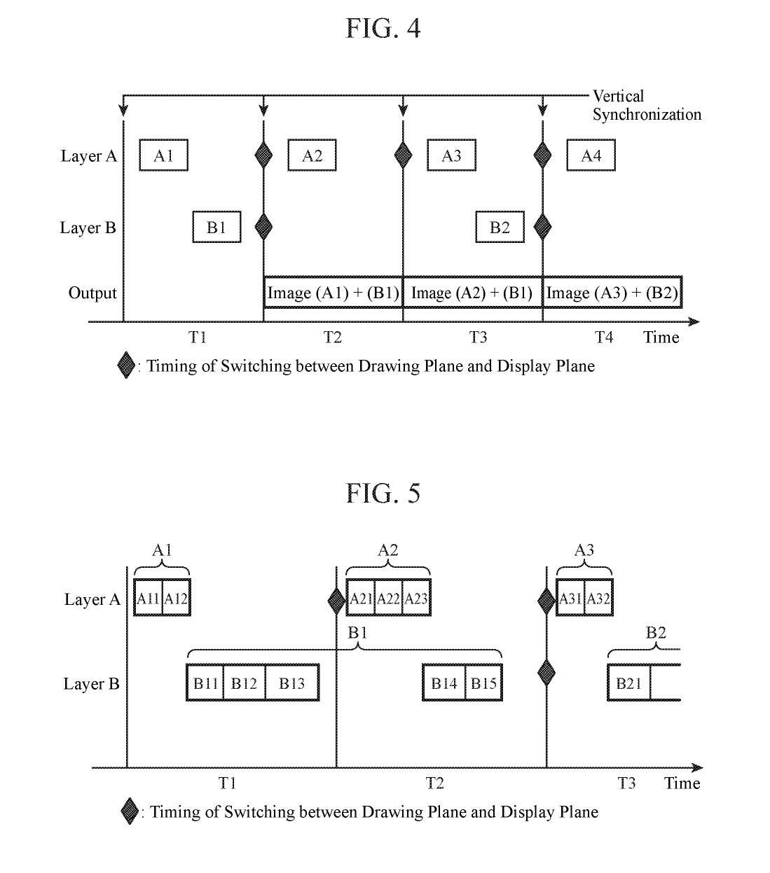

FIG. 4 is a timing chart for explaining the drawing process in each period in the drawing control apparatus according to First Embodiment. In this example, the image holding unit 5 has a layer A and a layer B. In each of periods T1, T2, T3 and T4 defined by vertical synchronization timing, the drawing unit 4 executes a corresponding one of drawing tasks A1, A2, A3, and A4 assigned to the layer A and/or a corresponding one of drawing tasks B1 and B2 assigned to the layer B.

Since the image holding unit 5 holding a plurality of layers comprises a double buffering configuration, drawing operations can be performed in different periods in different layers as illustrated in FIG. 4, which allows drawing operations to progress with different priority levels given to different layers.

In First Embodiment, suppose that one of two levels of priority of high and low is given to each drawing task, in which a task for drawing content with high priority will be referred to as a high-priority drawing task and a task for drawing content with low priority will be referred to as a low-priority drawing task.

The drawing task holding unit 1 holds the high-priority drawing task and the low-priority drawing task. Each drawing task is divided into drawing commands for respective graphic parts or the like, for example, and includes one or more drawing commands. In addition, each drawing task contains drawing time information for estimating a drawing time for each drawing command. The drawing time information includes parameters, such as drawing area drawn by a drawing command and viewpoint direction, for example.

For example, in a case in which the drawing control apparatus draws a meter to be displayed on, for example, a center display or integrated instrument panel of a vehicle, while the high-priority drawing task includes a drawing command for drawing an indicating needle of a meter and a drawing command for drawing a shadow of the indicating needle, the low-priority drawing task includes a drawing command for drawing a frame of the meter and a drawing command for drawing a scale.

The drawing time estimating unit 2 acquires a drawing task from the drawing task holding unit 1, and estimates the drawing time of each drawing command by using the drawing time information for each drawing command. The drawing time estimating unit 2 holds a mathematical expression using parameters, such as drawing area, which is obtained as drawing time information, and viewpoint direction, calculates, for example, a filling time dominated by the drawing area and a time required for coordinate transformation of a vertex to be drawn in accordance with the viewpoint direction, and estimates a drawing time for a drawing command.

The drawing adjustment unit 3 acquires drawing tasks held by the drawing task holding unit 1, and plans which drawing commands out of the high-priority drawing task and the low-priority drawing task are to be executed and in what sequence the drawing commands are to be executed. The drawing adjustment unit 3 receives a vertical synchronization signal from the output unit 6, and controls the drawing unit 4 in accordance with the plan in each predetermined period defined by vertical synchronization timing. This is necessary for executing the drawing tasks by switching between the drawing tasks at every limited time because the drawing unit 4 is a single unit and cannot execute a plurality of tasks simultaneously.

FIG. 5 is a timing chart for explaining a plan made by the drawing adjustment unit 3 of the drawing control apparatus according to First Embodiment. Herein, suppose that the drawing task holding unit 1 holds a high-priority drawing task A1 and a low-priority drawing task B1 to be executed in a period T1, a high-priority drawing task A2 to be executed in a period T2, and a high-priority drawing task A3 and a low-priority drawing task B2 to be executed in a period T3. The high-priority drawing task A1 includes drawing commands All and A12, the high-priority drawing task A2 includes drawing commands A21, A22, and A23, and the high-priority drawing task A3 includes drawing commands A31 and A32. The low-priority drawing task B1 includes drawing commands B11, B12, B13, B14, and B15, and the low-priority drawing task B2 includes at least a drawing command B21.

Suppose that information on an execution schedule, that is, information indicating which drawing task to be executed and in which period the drawing task is to be executed is held by the drawing task holding unit 1 in advance. The drawing adjustment unit 3 plans the sequence for executing the drawing tasks on the basis of the execution schedule.

When planning the execution sequence in the period T1, the drawing adjustment unit 3 assigns the high-priority drawing task A1 to the layer A of the image holding unit 5 and the low-priority drawing task B1 to the layer B. The drawing adjustment unit 3 also arranges the high-priority drawing task A1 at the beginning of the period T1, and the low-priority drawing task B1 after the high-priority drawing task A1. The drawing adjustment unit 3 further cumulatively adds each drawing time of the drawing commands A11, A12, B11, B12, B13, B14, and B15 that is estimated by the drawing time estimating unit 2 to calculate a completion time of the low-priority drawing task B1, and determines whether or not the low-priority drawing task B1 will be completed by vertical synchronization timing at the end of the period T1. In the example of FIG. 5, the drawing adjustment unit 3 determines that the drawing commands B14 and B15 of the low-priority drawing task B1 will not be completed by the vertical synchronization timing at the end of the period T1, and moves the drawing commands B14 and B15, which are not determined to be completed, to the next period T2.

In planning for the period T2, the drawing adjustment unit 3 assigns the high-priority drawing task A2 to the layer A similarly to the plan for the period T1. The drawing adjustment unit 3 also assigns the drawing commands B14 and B15 of the low-priority drawing task B1 moved from the period T1 to the period T2 to the layer B. The drawing adjustment unit 3 further arranges the high-priority drawing task A2 at the beginning of the period T2, and the drawing commands B14 and B15 of the low-priority drawing task B1 after the high-priority drawing task A2.

Although the drawing adjustment unit 3 arranges the drawing commands B14 and B15 of the low-priority drawing task B1 after the high-priority drawing task A2 because no low-priority drawing task to be executed in the period T2 is present in the example of FIG. 5, a low-priority drawing task to be executed in the period T2, if any, can be arranged after the high-priority drawing task A2. Furthermore, the drawing adjustment unit 3 can also discard the drawing commands B14 and B15 of the low-priority drawing task B1 depending on the remaining time.

As described above, when the unexecuted drawing commands B14 and B15 of the low-priority drawing task B1 moved from the period 1 to the period 2 and a low-priority drawing task originally planned to be executed in the period T2 are present, either may be given priority.

As illustrated in FIG. 5, since the drawing unit 4 executes the high-priority drawing tasks A1, A2, and A3 at the beginning of each of the periods T1, T2, and T3, there is a large time margin until the vertical synchronization timing even when the drawing time of the high-priority drawing task A1, A2, or A3 becomes longer than the estimated time, which facilitates guarantee of execution of the high-priority drawing tasks A1, A2, and A3.

In addition, forced halt and termination of a drawing command during execution of the command by the drawing unit 4 will cause such a problem as will be described in Second Embodiment described later, and thus interruption during execution is not preferable. Thus, when the drawing command B14 is executed following the drawing command B13 in the period T1, it is preferable to start execution of the high-priority drawing task A2 at least after execution of the drawing command B14 is completed. When, however, completion of execution of the drawing command B14 is waited for, start of execution of the high-priority drawing task A2 in the next period T2 is delayed, which decreases the time margin, and execution of the high-priority drawing task A2 cannot be guaranteed.

In contrast, as illustrated in FIG. 5, moving the drawing commands B14 and B15, which are not estimated to be completed by the vertical synchronization timing at the end of the period T1, to after the high-priority drawing task A2 in the next period T2 in advance allows the execution of the high-priority drawing task A2 to be guaranteed.

Next, operations of the drawing control apparatus will be described.

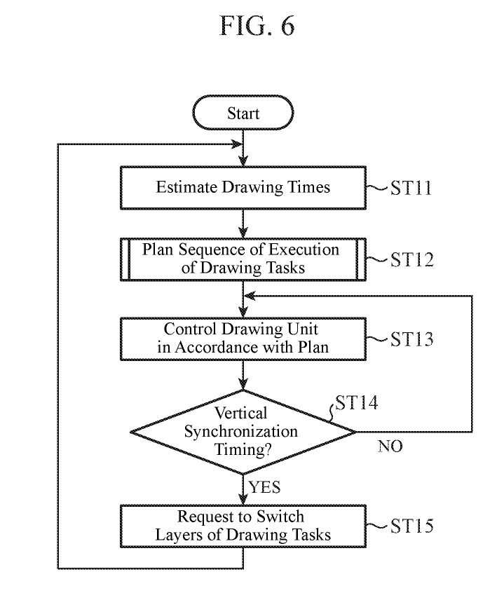

FIG. 6 is a flowchart illustrating the operation of the drawing control apparatus according to First Embodiment.

In step ST11, the drawing time estimating unit 2 acquires a high-priority drawing task and a low-priority drawing task to be executed in a current period from the drawing task holding unit 1. The drawing time estimating unit then estimates drawing times of all drawing commands included in the high-priority drawing task and the low-priority drawing task by using the drawing time information, and outputs the estimation result to the drawing adjustment unit 3.

In step ST12, the drawing adjustment unit 3 acquires the high-priority drawing task and the low-priority drawing task to be executed in a current period from the drawing task holding unit 1. The drawing adjustment unit 3 then determines layers to which the high-priority drawing task and the low-priority drawing task are to be assigned. The drawing adjustment unit 3 also plans the sequence for executing the high-priority drawing task and the low-priority drawing task on the basis of the estimation result of the drawing times received from the drawing time estimating unit 2. Details of the process of planning the execution sequence performed in step ST12 will be described later.

In step ST13, the drawing adjustment unit 3 controls the drawing unit 4 in accordance with the plan. Specifically, the drawing adjustment unit 3 outputs instructions on the layers to which the high-priority drawing task and the low-priority drawing task are to be assigned, instructions on the sequence for executing the drawing commands, and the like to the drawing unit 4.

In step ST14, the drawing adjustment unit 3 proceeds to step ST15 if the drawing adjustment unit 3 receives a vertical synchronization signal indicating vertical synchronization timing from the output unit 6 (“YES” in step ST14), or returns to step ST13 if vertical synchronization timing is not indicated (“NO” in step ST14).

In step ST15, the drawing adjustment unit 3 outputs, to the drawing unit 4, a request for switching between a display plane and a drawing plane of a layer to which the high-priority drawing task is assigned and a request for switching between a display plane and a drawing plane of a layer to which the low-priority drawing task is assigned. The drawing unit 4 in receipt of the requests switches the drawing planes of the layers on which drawing was performed during the current period to the display planes. The output unit 6 synthesizes images on the display planes of all the layers resulting from the switching, and outputs the synthesis result.

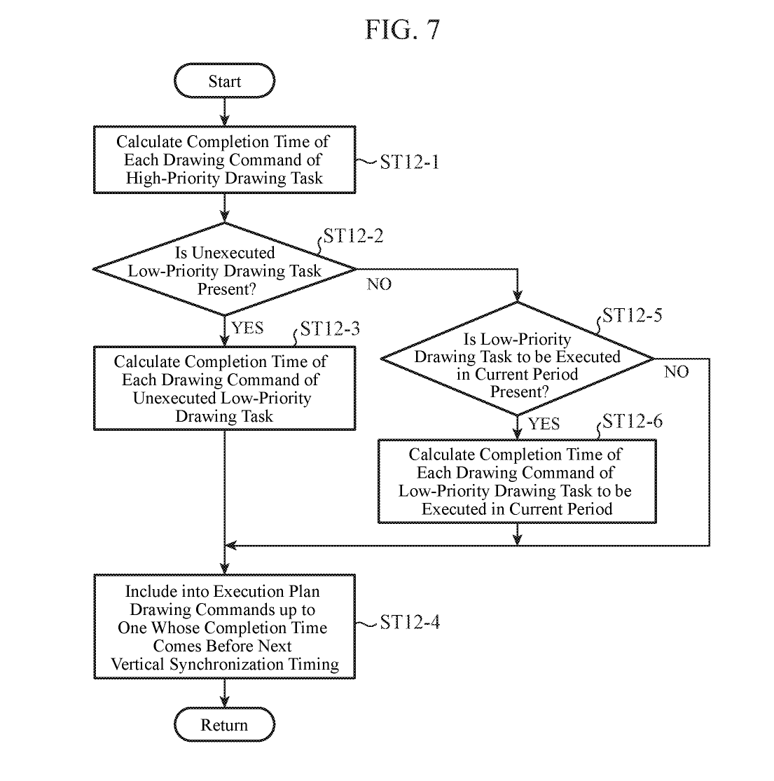

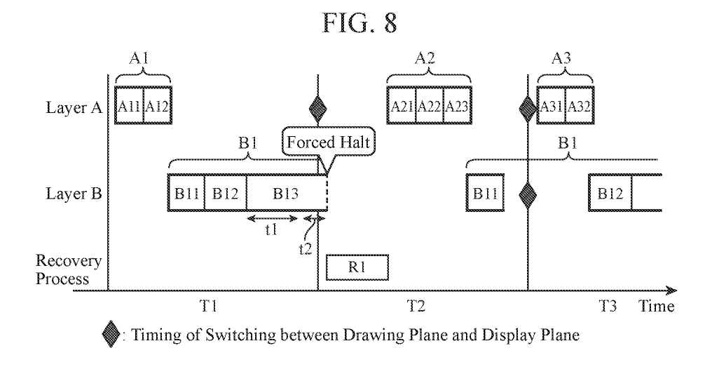

FIG. 7 is a flowchart illustrating details of the process of planning the execution sequence performed in step ST12 in FIG. 6.

In step ST12-1, the drawing adjustment unit 3 cumulatively adds an estimated time of each drawing command of the high-priority drawing task to be executed in the current period, and calculates a completion time of each drawing command of the high-priority drawing task.

In step ST12-2, the drawing adjustment unit 3 proceeds to step ST12-3 if any unexecuted drawing command of a low-priority drawing task moved from the previous period to the current period is present (“YES” in step ST12-2) or proceeds to step ST12-5 if no unexecuted drawing command is present (“NO” in step ST12-2).

In step ST12-3, the drawing adjustment unit 3 adds on the estimated times of the unexecuted drawing commands of the low-priority drawing task, which are moved from the previous period to the current period, to the completion time of the high-priority drawing task to be executed in the current period, and calculates a completion time of each unexecuted drawing command.

In subsequent step ST12-4, the drawing adjustment unit 3 includes all the drawing commands of a high-priority drawing task, for which real-time performance needs to be guaranteed certainly, into an execution plan for the current period. In contrast, as to a low-priority drawing task for which necessity of certainly guaranteeing the real-time performance is low, the drawing adjustment unit 3 includes, into the execution plan for the current period, drawing commands up to one whose completion time comes before the vertical synchronization timing occurring at the end of the current period, that is, the output timing of the current period, among the drawing commands left unexecuted in the previous period, and moves the drawing commands whose completion times go beyond the vertical synchronization timing at the end of the current period to the next period.

In step ST12-5, the drawing adjustment unit 3 proceeds to step ST12-6 if a low-priority drawing task originally planned to be executed in the current period is present (“YES” in step ST12-5), or proceeds to step ST12-4 if no low-priority drawing task originally planned to be executed in the current period is present (“NO” in step ST12-5).

In step ST12-6, the drawing adjustment unit 3 cumulatively adds on an estimated time of each drawing command of the low-priority drawing task to be executed in the current period to a completion time of the high-priority drawing task to be executed in the current period, and calculates a completion time of each drawing command of the low-priority drawing task.

In subsequent step ST12-4, the drawing adjustment unit 3 includes all the drawing commands of the high-priority drawing task to be executed in the current period into an execution plan for the current period. In contrast, the drawing adjustment unit 3 includes, into the execution plan for the current period, drawing commands up to one whose completion time comes before the vertical synchronization timing occurring at the end of the current period, that is, the output timing of the current period, among the drawing commands of the low-priority drawing task to be executed in the current period, and moves the drawing commands whose completion times go beyond the vertical synchronization timing at the end of the current period to the next period.

If no unexecuted drawing command of a low-priority drawing task moved from the previous period to the current period is present (“NO” in step ST12-2) and if no low-priority drawing task originally planned to be executed in the current period is present (“NO” in step ST12-5), the drawing adjustment unit 3 includes, in subsequent step ST12-4, all the drawing commands of the high-priority drawing task to be executed in the current period into an execution plan.

Although a high-priority drawing task is included in an execution plan for the current period without conditions while a low-priority drawing task is included in the execution plan for the current period or moved to the next period depending on the completion time in step ST12-4 in the above description, a high-priority drawing task may also be included in an execution plan for the current period or moved to the next period depending on a completion time.

Specifically, in step ST12-4 that is subsequent to step ST12-3, the drawing adjustment unit 3 includes, into an execution plan for the current period, drawing commands up to one whose completion time comes before the vertical synchronization timing occurring at the end of the current period, among the drawing commands of the high-priority drawing task to be executed in the current period and the unexecuted drawing commands of the low-priority drawing task that should have been executed in the previous period. On the other hand, the drawing adjustment unit 3 moves drawing commands whose completion time goes beyond the vertical synchronization timing at the end of the current period to the next period, among the drawing commands of the high-priority drawing task and the unexecuted drawing commands.

Furthermore, in step ST12-4 that is subsequent to step ST12-6, the drawing adjustment unit 3 includes, into an execution plan for the current period, drawing commands up to one whose completion time comes before the vertical synchronization timing occurring at the end of the current period, among the drawing commands of the high-priority drawing task to be executed in the current period and the drawing commands of the low-priority drawing task. On the other hand, the drawing adjustment unit 3 moves drawing commands whose completion time goes beyond the vertical synchronization timing at the end of the current period to the next period, among the drawing commands of the high-priority drawing task and the drawing commands of the low-priority drawing task.

Furthermore, in step ST12-4 that follows step ST12-5 “NO”, the drawing adjustment unit 3 includes, into an execution plan for the current period, drawing commands up to one whose completion time comes before the vertical synchronization timing occurring at the end of the current period, among the drawing commands of the high-priority drawing task to be executed in the current period, and moves the drawing commands whose completion time goes beyond the vertical synchronization timing at the end of the current period to the next period.

While an example in which two levels of priority of high and low are used for drawing tasks is presented in the description above, three or more levels of priority may be used.

For example, in a case in which three levels of priority of high, medium, and low are used and in which some of drawing commands of a medium-priority drawing task and all drawing commands of a low-priority drawing task have not been completed in the current period, the drawing adjustment unit 3 arranges the drawing commands of the medium-priority drawing task and all the drawing commands of the low-priority drawing task after a high-priority drawing task in the next period.

Alternatively, for example, in a case in which three levels of priority of high, medium, and low are used and some of drawing commands of a low-priority drawing task have not been completed in the current period, the drawing adjustment unit 3 arranges the drawing commands of the low-priority drawing task after a high-priority drawing task and a medium-priority drawing task in the next period.

As described above, the drawing control apparatus according to First Embodiment includes: the drawing unit 4 for drawing a plurality of images by executing a plurality of drawing tasks, each given a priority level, in each period; the output unit 6 for combining and outputting the images drawn by the drawing unit 4 in each period; the drawing time estimating unit 2 for estimating the drawing time of each of one or more drawing commands included in the drawing tasks; and the drawing adjustment unit 3 for planning a sequence for executing the drawing tasks on the basis of the drawing times estimated by the drawing time estimating unit 2 and controlling the drawing unit 4, in which the drawing adjustment unit 3 is configured to cause the drawing unit 4 to execute a plurality of drawing tasks planned to be executed in the current period in descending order of priority and to execute some or all of the drawing commands of drawing tasks that have not been completed by the output timing, at which output of images drawn in the current period is started, after execution of drawing tasks with higher priority than the uncompleted drawing tasks in the next period. More specifically, when the drawing unit 4 is caused to execute a plurality of drawing tasks planned to be executed in the current period in descending order of priority on the basis of the drawing times estimated by the drawing time estimating unit 2, the drawing adjustment unit 3 causes drawing commands determined not to be completed by the output timing of the current period to be executed after execution of drawing tasks with higher priority than the drawing commands, which are determined not to be completed, in the next period. This ensures execution of a drawing task with high priority in each period.

### Second Embodiment

While drawing time for each drawing command is estimated in the drawing control apparatus according to First Embodiment described above, the drawing time is not always accurately estimated, and may be longer than estimated. In addition, drawing may not be successfully completed owing to failure of the drawing unit or other reasons.

Thus, in Second Embodiment, a drawing control apparatus capable of guaranteeing execution of a high-priority drawing task even when the drawing time has increased to be longer than estimated is achieved. Since the configuration of the drawing control apparatus according to Second Embodiment appears the same on the drawing as that of First Embodiment illustrated in FIG. 1, FIG. 1 will be referred to below.

FIG. 8 is a timing chart for explaining a plan made by a drawing adjustment unit 3 of the drawing control apparatus according to Second Embodiment. Herein, assume that a drawing task holding unit 1 holds a high-priority drawing task A1 and a low-priority drawing task B1 to be executed in a period T1, a high-priority drawing task A2 to be executed in a period T2, and a high-priority drawing task A3 to be executed in a period T3. The high-priority drawing task A1 includes drawing commands A11 and A12, the high-priority drawing task A2 includes drawing commands A21, A22, and A23, and the high-priority drawing task A3 includes drawing commands A31 and A32. The low-priority drawing task B1 includes drawing commands B11, B12, and B13.

The drawing adjustment unit 3 in Second Embodiment assigns the high-priority drawing task A1 to a layer A of the image holding unit 5 and the low-priority drawing task B2 to the layer B, and arranges the low-priority drawing task B1 after the high-priority drawing task A1, similarly to First Embodiment. The drawing adjustment unit 3 further sums the drawing times for drawing commands A11, A12, B11, B12, and B13 estimated by the drawing time estimating unit 2, and calculates the time at which the last drawing command B13 will be completed. Assume herein that the drawing adjustment unit 3 determines that the high-priority drawing task A1 and the low-priority drawing task B1 will be completed by the vertical synchronization timing at the end of the period T1. Further assume that the drawing adjustment unit 3 has planned to execute the high-priority drawing task A1 and the low-priority drawing task B1 in this sequence in the current period T1 on the basis of the determination.

Further assume that, while the drawing adjustment unit 3 controls the drawing unit 4 in accordance with the plan, the time it takes for the drawing unit 4 to draw in accordance with the drawing command B13 of the low-priority drawing task B1 has increased by time t2 from the estimated drawing time t1 as illustrated in FIG. 8. In this case, upon detecting that the drawing unit 4 has reached the vertical synchronization timing at the end of the period T1 while executing the drawing command B13, the drawing adjustment unit 3 forcedly halts and terminates the execution of the drawing command B13. The drawing unit 4 then performs a recovery process R1, and thereafter, the drawing adjustment unit 3 causes the drawing unit 4 to execute the high-priority drawing task A2.

In this case, since the drawing adjustment unit 3 has forcedly halted and terminated the drawing command B13 of the low-priority drawing task B1 in the drawing unit 4, the drawing adjustment unit 3 makes a plan to re-execute the terminated low-priority drawing task B1 from the first drawing command B11 after executing the high-priority drawing task A2 in the period T2.

For example, in a case in which the content of the drawing command B11 is to draw a frame of a meter and the content of the drawing command B13 is to draw a scale on the image of the frame, forced halt of the drawing command B13 results in an image in which the scale is partially drawn on the frame, which makes it difficult to accurately know how much the drawing has been performed. Thus, it is desirable to redraw the frame image by re-executing the low-priority drawing task B1 from the beginning rather than from the forcedly halted drawing command B13.

Next, operation of the drawing control apparatus will be described.

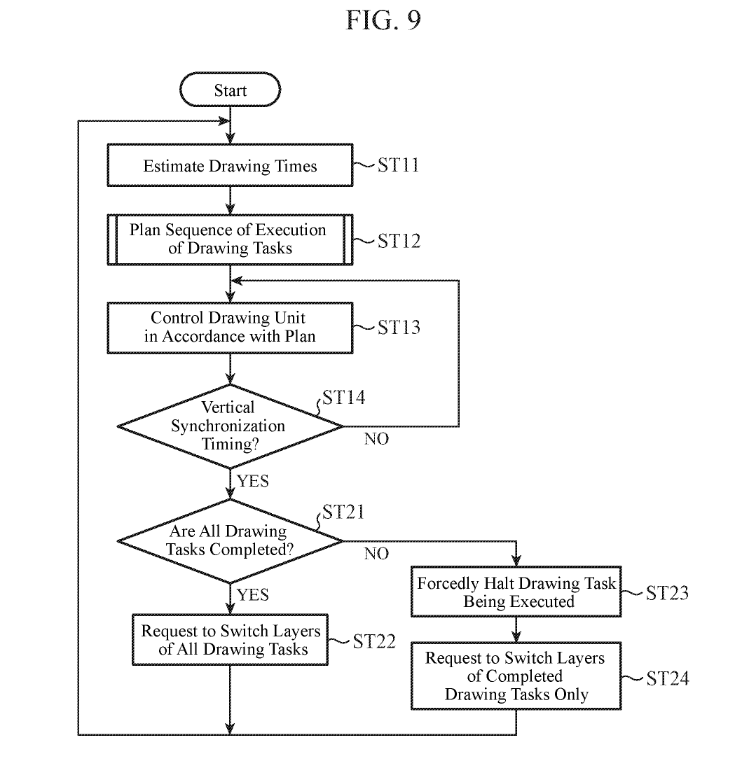

FIG. 9 is a flowchart illustrating the operation of the drawing control apparatus according to Second Embodiment. Processes performed in steps ST11 to ST14 in FIG. 9 are the same as those explained in steps ST11 to ST14 in FIG. 6.

In step ST14, the drawing adjustment unit 3 proceeds to step ST21 if the drawing adjustment unit 3 receives a vertical synchronization signal indicating vertical synchronization timing from the output unit 6 (“YES” instep ST14), or returns to step ST13 if vertical synchronization timing is not indicated (“NO” in step ST14).

In step ST21, the drawing adjustment unit 3 proceeds to step ST22 if a high-priority drawing task and a low-priority drawing task planned to be executed in the current period are all completed (“YES” in step ST21), or proceeds to step ST23 if the high-priority drawing task or the low-priority drawing task planned to be executed in the current period has not been completed (“NO” in step ST21).

Note that a drawing task planned to be executed in the current period may be a drawing task indicated by information on an execution plan held in advance in the drawing task holding unit 1, or may be a drawing task moved from the previous period to the current period and planned to be executed in the current period by the drawing adjustment unit 3.

In step ST22, the drawing adjustment unit 3 outputs, to the drawing unit 4, a request for switching a display plane and a drawing plane of a layer to which the high-priority drawing task is assigned and a request for switching a display plane and a drawing plane of a layer to which the low-priority drawing task is assigned. The drawing unit 4 in receipt of the requests switches the drawing planes of the layers on which drawing is performed during the current period to the display planes. The output unit 6 synthesizes images on the display planes of all the layers resulting from the switching, and outputs the synthesized result.

In step ST23, the drawing adjustment unit 3 outputs an instruction to terminate the drawing command of the drawing task being executed before completion and an instruction to clear the terminated drawing task and the layer to which the drawing task is assigned to the drawing unit 4. The drawing unit 4 in receipt of the instructions terminates the drawing command of the drawing task being executed, and performs a recovery process of clearing the layer to which the drawing task is assigned, and the like.

In step ST24, the drawing adjustment unit 3 outputs, to the drawing unit 4, a request to switch the display plane and drawing plane of layers in which an assigned drawing task has been completed by the vertical synchronization timing. The drawing unit 4 in receipt of the request switches the drawing planes that are drawn in the current period to the display planes, only for the requested layers. The output unit 6 then synthesizes images on the display planes of all the layers, and outputs the synthesized result.

The processes performed in step ST12 of FIG. 9 are the same as those of the steps other than step ST12-3 in the flowchart illustrated in FIG. 7 according to First Embodiment. While the drawing adjustment unit 3 according to First Embodiment calculates the completion times only for the unexecuted drawing commands and determines whether or not to include the unexecuted drawing commands into the execution plan in step ST12-3, the drawing adjustment unit 3 according to Second Embodiment calculates the completion times of all the drawing commands included in the forcedly halted drawing task and determines whether or not to include the halted drawing commands into the execution plan.

While an example in which two levels of priority of high and low are used for drawing tasks is presented in the description above, three or more levels of priority may be used.

As described above, according to Second Embodiment, when the drawing unit 4 is caused to execute a plurality of drawing tasks planned to be executed in the current period in descending order of priority but the execution is not completed by the output timing of the current period, the drawing adjustment unit 3 terminates execution of an uncompleted drawing task and causes the uncompleted drawing task to be executed from the first drawing command thereof after execution of drawing tasks with higher priority than the uncompleted drawing task in the next period, which allows drawing tasks with high priority to be surely executed even when the drawing time is longer than estimated.

### Third Embodiment

While a configuration in which, when a drawing task planned to be executed in the current period is not completed by the output timing of the current period, the drawing task is terminated at the output timing of the current period is used in the drawing control apparatus according to Second Embodiment described above, the timing for termination is later than the output timing of the current period in Third Embodiment. Since the configuration of the drawing control apparatus according to Third Embodiment appears the same on the drawing as that of First Embodiment illustrated in FIG. 1, FIG. 1 will be referred to below.

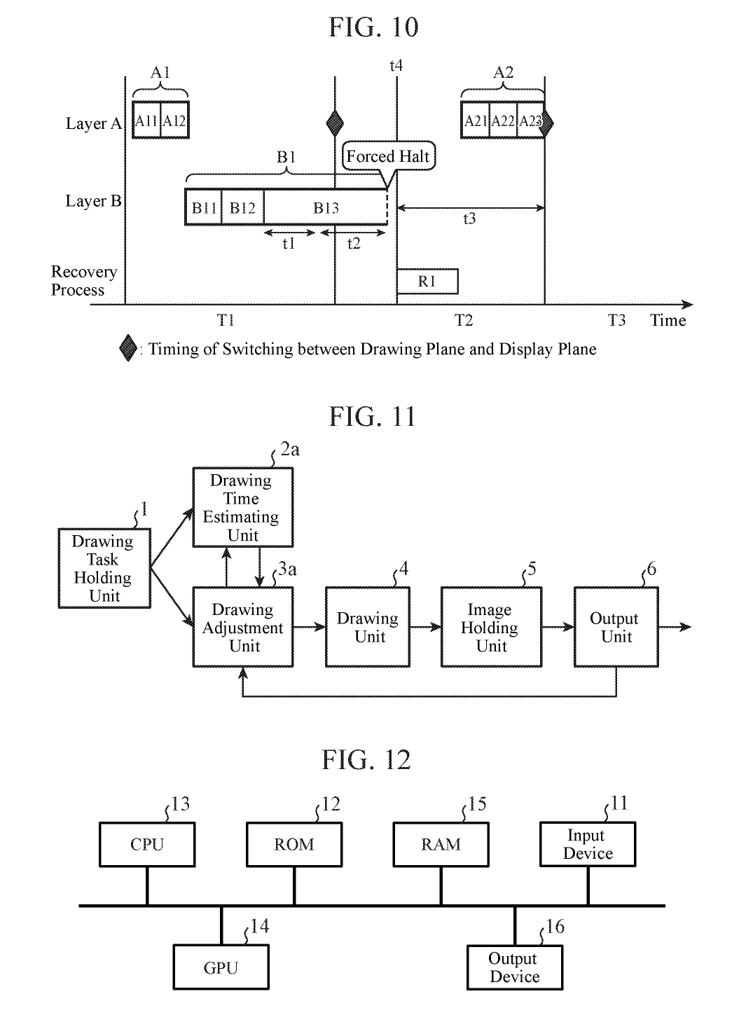

FIG. 10 is a timing chart for explaining a plan made by a drawing adjustment unit 3 of the drawing control apparatus according to Third Embodiment. Herein, assume that a drawing task holding unit 1 holds a high-priority drawing task A1 and a low-priority drawing task B1 to be executed in a period T1, and a high-priority drawing task A2 to be executed in a period T2. The high-priority drawing task A1 includes drawing commands A11 and A12, and the high-priority drawing task A2 includes drawing commands A21, A22, and A23. The low-priority drawing task B1 includes drawing commands B11, B12, and B13.

In planning for the period T1, the drawing adjustment unit 3 in Third Embodiment adds the drawing time of the high-priority drawing task A2 planned to be executed in the next period T2 and the recovery time for a recovery process R1 from termination of a drawing task being executed by the drawing unit 4 until start of execution of a next drawing task on the basis of the drawing times estimated by the drawing time estimating unit 2, and calculates a reference time t3. Then, even when the low-priority drawing task B1 planned to be executed in the current period T1 is not completed by the vertical synchronization timing at the end of the period T1, the drawing adjustment unit 3 does not terminate the low-priority drawing task B1 until time t4, which is prior to the vertical synchronization timing at the end of the next period T2 by the reference time t3, and terminates the drawing command B13 of the low-priority drawing task B1 only when the drawing command B13 is not completed at time t4. The drawing unit 4 then performs the recovery process R1, and thereafter, the drawing adjustment unit 3 causes the drawing unit 4 to execute the high-priority drawing task A2 and subsequently re-execute the terminated low-priority drawing task B1 from the first drawing command B11.

This allows the drawing unit 4 to avoid performing the recovery process R1 and re-executing the drawing commands B11, B12, and B13 when execution of the drawing command B13 took longer than the drawing time t1 estimated by the drawing time estimating unit 2 but completed successfully.

Note that, since the estimation of the drawing times by the drawing time estimating unit 2 may have an error, the drawing adjustment unit 3 may add a predetermined time to the drawing time of the drawing task A2 given priority and the recovery time for the recovery process R1 to obtain a reference time t3. The predetermined time is a time set in view of an error that may be caused in estimation of drawing times, and is set in advance in the drawing adjustment unit 3.

In addition, while an example in which two levels of priority of high and low are used for drawing tasks is presented in the description above, three or more levels of priority may be used. For example, when three or more levels of priority are used, the drawing adjustment unit 3 may calculate the reference time by adding the drawing time of a drawing task given a highest level of priority whose real-time performance needs to be certainly guaranteed and the recovery time.

As described above, according to Third Embodiment, the drawing adjustment unit 3 calculates the reference time by adding the drawing time of a drawing task with the highest priority among a plurality of drawing tasks planned to be executed in the next period and the recovery time from termination of a drawing task being executed until start of execution of a next drawing task, causes the drawing unit 4 to execute a plurality of drawing tasks planned to be executed in the current period in descending order of priority, and when the execution is not completed before the reference time prior to the output timing of the next period, terminates execution of an uncompleted drawing task and causes the uncompleted drawing task to be executed from the first drawing command thereof after execution of the drawing tasks with higher priority than the uncompleted drawing task in the next period, which ensures drawing tasks with high priority even when the drawing time is longer than estimated. In addition, when execution of a drawing task with low priority took longer than estimated but completed successfully, the recovery process need not be performed and the drawing task need not be re-executed from the first drawing command thereof.

### Fourth Embodiment

While the drawing time is estimated for each drawing command in the drawing control apparatus according to First to Third embodiments described above, the drawing time is not always accurately estimated, and may be longer or shorter than estimated.

Thus, in Fourth Embodiment, a drawing control apparatus that increases the accuracy of estimation of drawing times will be achieved.

FIG. 11 is a block diagram illustrating an example configuration of the drawing control apparatus according to Fourth Embodiment. In FIG. 11, parts that are the same as or correspond to those in FIG. 1 will be designated by the same reference numerals, and the description thereof will not be repeated.

A drawing adjustment unit 3a in Fourth Embodiment measures a drawing time taken to execute a drawing command in the drawing unit 4, and notifies a drawing time estimating unit 2a of the measured drawing time as an actual measured drawing time.

The drawing time estimating unit 2a in Fourth Embodiment receives an actual measured drawing time for each drawing command from the drawing adjustment unit 3a, and increases or decreases an estimated drawing time depending on the actual measured drawing time.

For example, the drawing time estimating unit 2a holds Expression (1), calculates a filling time dependent on a drawing area s by using Expression (1), and uses the calculated filling time as an estimated drawing time ts of a drawing command.

ts=c(4s+10) (1)

In the expression, s is a parameter representing the drawing area drawn by a drawing command, that is drawing time information of each drawing command included in a drawing task. The letter c represents a correction coefficient.

The drawing time estimating unit 2a compares an estimated drawing time estimated by using expression (1) for a drawing command with an actual measured drawing time notified from the drawing adjustment unit 3a, and makes the correction coefficient c larger when the actual measured drawing time is longer than the estimated drawing time or makes the correction coefficient c smaller when the actual measured drawing time is shorter than the estimated drawing time. This increases the accuracy of estimation of a drawing time in the next estimation.

Note that the drawing time estimating unit 2a may increase or decrease the correction coefficient c by a fixed value (0.1, for example), or may obtain a value depending on a difference between or a ratio of the estimated drawing time and the actual measured drawing time and increase or decrease the correction coefficient c by the obtained value.

In addition, when a drawing command being executed is terminated in Second and Third embodiments, the drawing adjustment unit 3a may measure the time from start of execution of the drawing command to the termination and notify the drawing time estimating unit 2a of the measured time as an actual measured drawing time.

The drawing time estimating unit 2a receives an actual measured drawing time of each drawing command from the drawing adjustment unit 3a, and increases or decreases an estimated drawing time depending on the actual measured drawing time, similarly to the above.

This increases the accuracy of estimation of a drawing time in the next estimation even when execution of a drawing command is terminated before being completed.

As described above, according to Fourth Embodiment, the drawing time estimating unit 2a is configured to increase or decrease an estimated drawing time depending on the time actually measured from start of execution of a drawing command by the drawing unit 4 until completion of the drawing command, which increases the accuracy of estimation of the drawing time.

In addition, according to Fourth Embodiment, the drawing time estimating unit 2a is configured to increase or decrease an estimated drawing time depending on the time actually measured from start of execution of a drawing command by the drawing unit 4 until termination of the drawing command, which increases the accuracy of estimation of the drawing time even when execution of a drawing command is terminated before being completed.

Next, an exemplary hardware configuration of the drawing control apparatus according to the embodiments of this disclosure will be described. FIG. 12 is a hardware configuration diagram of the drawing control apparatus according to First to Fourth Embodiments.

The drawing task holding unit 1 is an input device 11. The input device 11 receives a drawing instruction from an application program for displaying a meter, for example, on a center display of a vehicle, converts the drawing instruction into drawing tasks to be executed by the drawing unit 4, and holds the drawing tasks.

The functions of the drawing time estimating unit 2 and the drawing adjustment unit 3 are realized by a central processing unit (CPU) 13 for executing programs stored in a read only memory (ROM) 12.

The functions of the drawing time estimating unit 2 and the drawing adjustment unit 3 are realized by software, firmware, or combination of software and firmware. The software or firmware is described in the form of programs and stored in the ROM 12. The CPU 13 realizes the functions of the respective units by reading and executing the programs stored in the ROM 12. That is, drawing control apparatus includes the ROM 12 for storing programs to be executed by the CPU 13, which results in execution of a step of estimating the drawing time for each of one or more drawing commands included in each drawing task and a step of controlling the drawing unit 4 by planning a sequence for executing a plurality of drawing tasks. Note that these programs can be thought as a thing that causes a computer to execute the procedures or methods of the drawing time estimating unit 2 and the drawing adjustment unit 3.

The drawing unit 4 is a graphics processing unit (GPU) 14 such as a three-dimensional graphics processor. The image holding unit 5 is a random access memory (RAM) 15. The output unit 6 is an output device 16. The output device 16 outputs an image of the drawn meter to the center display of the vehicle, for example.

Note that combination, modification or omission of components of the embodiments may be freely made within the scope of the invention.

### INDUSTRIAL APPLICABILITY

A drawing control apparatus according to this disclosure changes the sequence in which drawing tasks are to be executed on the basis of priority levels given to the drawing tasks, and is thus suitable for use for a drawing control apparatus including a three-dimensional graphics processor for which it is difficult to interrupt a drawing process at certain timing and switch to another drawing process, and the like.

### REFERENCE SIGNS LIST

1: drawing task holding unit, 2, 2a: drawing time estimating unit, 3, 3a: drawing adjustment unit, 4: drawing unit, 5: image holding unit, 6: output unit, 11: input device, 12: ROM, 13: CPU, 14: GPU, 15: RAM, 16: output device

1. A drawing control apparatus comprising:
a processor to execute a program; and
a memory to store the program which, when executed by the processor, results in performance of:
executing in each period defined by vertical synchronization timing a plurality of drawing tasks given a priority level, and drawing a plurality of images;
synthesizing and outputting the drawn images in each period;
estimating a drawing time of each of one or more drawing commands included in a drawing task; and
planning an execution sequence of the plurality of drawing tasks on a basis of the estimated drawing times wherein
the processor is configured to execute in descending order of priority level the plurality of drawing tasks that is planned to be executed in a current period, and to execute some or all of the drawing commands of a drawing task that is not expected to be completed by output timing at which outputting of images that are drawn in the current period is started in a next period after executing a drawing task with a priority level higher than the drawing task that is not expected to be completed.

2. The drawing control apparatus according to claim 1, wherein the processor is configured to execute a drawing command that is not determined to be completed by the output timing of the current period if the plurality of drawing tasks that is planned to be executed in the current period in descending order of priority level is executed, on a basis of the estimated drawing times, in the next period after executing a drawing task with a priority level higher than a drawing task that includes the drawing command that is not determined to be completed.

3. The drawing control apparatus according to claim 1, wherein when the processor executes the plurality of drawing tasks that is planned to be executed in the current period in descending order of priority level but the execution is not completed by the output timing of the current period, the processor terminates execution of an uncompleted drawing task and causes the uncompleted drawing task to be executed in the next period from a first drawing command of the uncompleted drawing task after execution of a drawing task with a priority level higher than the uncompleted drawing task.

4. The drawing control apparatus according to claim 1, wherein the processor calculates a reference time by adding a drawing time of a drawing task with a highest priority level among the plurality of drawing tasks that is planned to be executed in the next period and a recovery time from termination of a drawing task being executed until start of execution of a next drawing task, executes the plurality of drawing tasks that is planned to be executed in the current period in descending order of priority level, and when the execution is not completed before the reference time prior to the output timing of the next period, terminates execution of an uncompleted drawing task and causes the uncompleted drawing task to be executed in the next period from a first drawing command of the uncompleted drawing task after execution of a drawing task with a priority level higher than the uncompleted drawing task.

5. The drawing control apparatus according to claim 1, wherein the processor is configured to increase or decrease an estimated drawing time depending on a time actually measured from start of execution of a drawing command until completion of the drawing command.

6. The drawing control apparatus according to claim 3, wherein the processor is configured to increase or decrease an estimated drawing time depending on a time actually measured from start of execution of a drawing command until termination of the drawing command.

7. The drawing control apparatus according to claim 4, wherein the processor is configured to increase or decrease an estimated drawing time depending on a time actually measured from start of execution of a drawing command until termination of the drawing command.
